(19) United States
(12) Patent Application Publication
(10) Pub. No.: US 2016/0277600 A1
(43) Pub. Date: Sep. 22, 2016

(54) DATA TRANSFER CONTROL DEVICE, IMAGE PROCESSING APPARATUS, DATA TRANSFER SYSTEM, AND DATA TRANSFER CONTROL METHOD

(71) Applicant: Ken TAKAHASHI, Tokyo (JP)

(72) Inventor: Ken TAKAHASHI, Tokyo (JP)

(21) Appl. No.: 14/973,880

(22) Filed: Dec. 18, 2015

(30) Foreign Application Priority Data
Mar. 19, 2015 (JP) 2015-056825

(51) Int. Cl. H04N 1/00; G06F 3/12; H04N 1/32

(52) U.S. Cl. CPC H04N 1/00095; H04N 1/32363; G06F 3/1207; G06F 3/1275; G06F 3/1293; G06F 3/1239; H04N 2201/0094

(57) ABSTRACT

A data transfer control device controls a data transfer process based on data transfer requests, and includes a delay time measurement unit, an operation state information acquisition unit, and a transfer control unit. The delay time measurement unit measures a delay time in data transfer occurring in the data transfer process. The operation state information acquisition unit acquires operation state information indicating one of an operating state and a non-operating state of a transfer restricted module that issues the data transfer requests and is subjected to a predetermined restriction in the data transfer. The transfer control unit limits a transmission amount of the data transfer requests issued by the transfer restricted module, if the measured delay time is at least a predetermined threshold and the acquired operation state information indicates the operating state of the transfer restricted module.

### CROSS-REFERENCE TO RELATED APPLICATION

This patent application is based on and claims priority pursuant to 35 U.S.C. §119(a) to Japanese Patent Application No. 2015-056825 filed on Mar. 19, 2015, in the Japan Patent Office, the entire disclosure of which is hereby incorporated by reference herein.

### BACKGROUND

1. Technical Field

This disclosure relates to a data transfer control device, an image processing apparatus, a data transfer system, and a data transfer control method.

2. Related Art

With digitization of information promoted in recent years, an image processing apparatus, such as a printer or a facsimile machine used to output digitized information or a scanner used to digitize documents, has been widely used. Such an image processing apparatus is often provided with functions such as imaging, image formation, and communication to be configured as a multifunction peripheral (MFP) usable as a printer, a facsimile machine, a scanner, and a copier.

In the above-described image processing apparatus, image data is transferred between an arithmetic device that performs a variety of image processing, such as an application specific integrated circuit (ASIC), and a controller that controls a memory for reading and writing data. Such image data is transferred via Peripheral Component

Interconnect Express (PCIe; registered trademark), which is an interface that performs high-speed data transfer.

### SUMMARY

In one embodiment of this disclosure, there is provided an improved data transfer control device that controls a data transfer process based on data transfer requests and includes, for example, a delay time measurement unit, an operation state information acquisition unit, and a transfer control unit. The delay time measurement unit measures a delay time in data transfer occurring in the data transfer process. The operation state information acquisition unit acquires operation state information indicating one of an operating state and a non-operating state of a transfer restricted module that issues the data transfer requests and is subjected to a predetermined restriction in the data transfer. The transfer control unit limits a transmission amount of the data transfer requests issued by the transfer restricted module, if the measured delay time is at least a predetermined threshold and the acquired operation state information indicates the operating state of the transfer restricted module.

In one embodiment of this disclosure, there is provided an improved image processing apparatus that includes the above-described data transfer control device and performs image processing on image data subjected to data transfer control by the data transfer control device.

In one embodiment of this disclosure, there is provided an improved data transfer system that includes the above-described data transfer control device and a request receiver to receive the data transfer requests transmitted from the data transfer control device.

In one embodiment of this disclosure, there is provided an improved data transfer control method of controlling a data transfer process based on data transfer requests. The data transfer control method includes, for example, measuring a delay time in data transfer occurring in the data transfer process, acquiring operation state information indicating one of an operating state and a non-operating state of a transfer restricted module that issues the data transfer requests and is subjected to a predetermined restriction in the data transfer, and limiting a transmission amount of the issued data transfer requests if the measured delay time is at least a predetermined threshold and the acquired operation state information indicates the operating state of the transfer restricted module.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of a hardware configuration of an image processing apparatus according to an embodiment of this disclosure;

FIG. 2 is a block diagram illustrating an example of a configuration of an image processing unit in the image processing apparatus according to the embodiment;

FIG. 3 is a flowchart illustrating an example of a flow control operation performed by a flow control unit in the image processing unit according to the embodiment;

FIG. 4 is a flowchart illustrating an example of an operation of controlling transmission of data transfer requests performed by a PCIe communication core in the image processing unit according to the embodiment;

FIG. 5 is a flowchart illustrating an example of an operation of responding to an instruction to limit credit performed by the PCIe communication core according to the embodiment;

FIGS. 6A and 6B are diagrams conceptually illustrating examples of a credit value according to the embodiment;

FIG. 7 is a block diagram illustrating another example of the configuration of the image processing unit according to the embodiment;

FIG. 8 is a block diagram illustrating another example of the configuration of the image processing unit according to the embodiment; and

FIG. 9 is a block diagram illustrating another example of the configuration of the image processing unit according to the embodiment.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same function, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The transfer of data such as image data via Peripheral Component Interconnect Express (PCIe; registered trademark) may involve latency. To eliminate such latency, the amount of data transfer requests may be limited in a data transfer system that transfers data between multiple devices via PCIe. Specifically, in the data transfer system, a device that receives data transfer requests may measure the rate of data transfer from a device that transmits data transfer requests, and may limit the amount of data transfer requests based on the measurement result.

A typical image processing apparatus, however, performs two types of processes: processes strictly limiting the time until the completion of transfer of a predetermined amount of data and thus requiring latency to be eliminated, and processes not strictly limiting the time until the completion of transfer of a predetermined amount of data and thus not requiring latency to be eliminated. For example, the transfer of image data between a memory and a plotter that forms and outputs an image onto a sheet is required to be performed in proper timing with the operation of the plotter. In this case, therefore, the time until the completion of transfer of one line of data is strictly limited. By contrast, the data transfer between the memory and an image editing unit that scales images is not required to be performed in proper timing with the operation of an external device. In this case, therefore, the time until the completion of transfer of a predetermined amount of data is not strictly limited.

If the amount of data transfer requests is limited in a process not requiring the elimination of latency, the data transfer may be limited, degrading overall performance of the data transfer system.

The above-described issue may arise not only in the control of image data transfer in an image processing apparatus but also in a data transfer control device that controls data transfer via PCIe to perform a variety of processing other than image processing.

It is therefore desirable to prevent the degradation in overall performance of a device or apparatus, while limiting the amount of data transfer requests to eliminate latency.

Referring now to the drawings, wherein like reference numerals designate identical or corresponding parts throughout the several views, an embodiment of this disclosure will be described in detail. In the present embodiment, a description will be given of, for example, an image processing apparatus provided with functions such as imaging, image formation, and communication to be configured as a multifunction peripheral (MFP) usable as a printer, a facsimile machine, a scanner, and a copier.

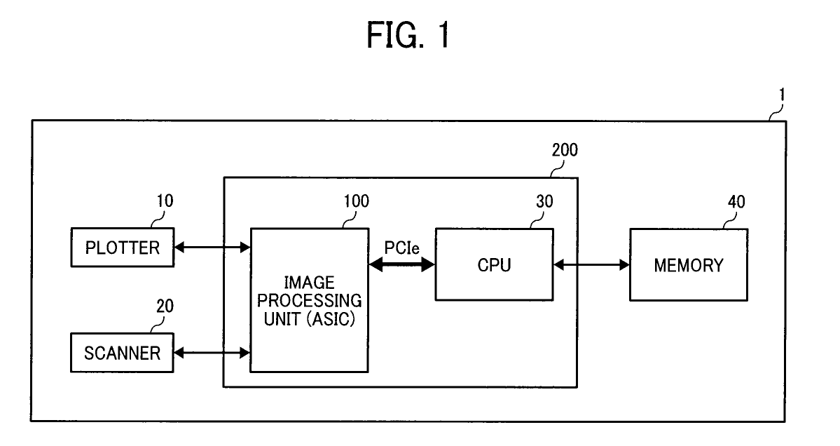

FIG. 1 is a block diagram illustrating an example of a hardware configuration of an image processing apparatus 1 according to the present embodiment related to the transfer of image data. As illustrated in FIG. 1, the image processing apparatus 1 according to the present embodiment includes a plotter 10, a scanner 20, a central processing unit (CPU) 30, a memory 40, and an image processing unit 100. The CPU 30 and the image processing unit 100 are connected to each other via PCIe.

The plotter 10 forms and outputs an image onto a sheet based on image data for forming and outputting the image. The scanner 20 reads a document to generate image data (hereinafter referred to as scanned data). The CPU 30 controls the operation of the image processing unit 100, and controls writing and reading of data to and from the memory 40 in response to data transfer requests transmitted from the image processing unit 100. The memory 40 is a storage area for storing image data. Image data is written to the memory 40 or image data stored in the memory 40 is read in accordance with the control of the CPU 30.

The image processing unit 100 is a device dedicated to a variety of image processing, and is implemented by an arithmetic device such as an application specific integrated circuit (ASIC). For example, the image processing unit 100 transmits data transfer requests to the CPU 30, and acquires image data stored in the memory 40 or transfers image data to the memory 40 via PCIe.

Specifically, for example, the image processing unit 100 receives an externally input print instruction and sends the CPU 30 memory read requests for reading image data stored in the memory 40. Thereby, the image processing unit 100 acquires the image data read and transferred from the memory 40 under the control of the CPU 30, and transfers the acquired image data to the plotter 10. The plotter 10 then forms and outputs an image onto a sheet based on the transferred image data. That is, the memory read requests correspond to the data transfer requests in this case.

Further, for example, the image processing unit 100 receives an externally input document read instruction and acquires the scanned data generated by the scanner 20. The image processing unit 100 then sends the CPU 30 the acquired scanned data and memory write requests for writing image data to the memory 40. Thereby, the scanned data is stored in the memory 40. That is, the memory write requests correspond to the data transfer requests in this case.

In the present embodiment, the image processing unit 100 functions as a data transfer control device that controls a data transfer process based on data transfer requests, and the CPU 30 functions as a request receiver that receives the data transfer requests from the image processing unit 100. The data transfer control device (i.e., the image processing unit 100) and the request receiver (i.e., the CPU 30) form a data transfer system (i.e., a data transfer system 200 in FIG. 1).

As described above, the image processing unit 100 needs to transfer image data from the memory 40 to the plotter 10 in proper timing with the operation of mechanical components of the plotter 10. It is therefore necessary to complete the transfer of a predetermined amount of image data to the plotter 10 within a predetermined time period (e.g., tens of microseconds), and the time until the completion of the data transfer is strictly limited. If the transfer of the predetermined amount of image data fails to complete within the predetermined time period, the image data necessary for the plotter 10 to form and output an image fails to be properly transferred. Consequently, an abnormal image with white spots or noise is formed on the sheet.

It is similarly necessary to complete the transfer of a predetermined amount of image data from the scanner 20 to the memory 40 within a predetermined time period (e.g., tens of microseconds). That is, the time until the completion of the data transfer is strictly limited. If the transfer of the predetermined amount of image data fails to complete within the predetermined time period, the image data generated by the scanner 20 fails to be properly stored in the memory 40. Consequently, an abnormal image with white spots or noise is stored in the memory 40.

In the transfer of image data in an image output process or an image input process, such as the transfer of image data to the plotter 10 or the transfer of image data from the scanner 20 by the image processing unit 100, therefore, latency is required to be eliminated. Some of the processes performed by the image processing unit 100, however, do not strictly limit the time until the completion of the transfer of a predetermined amount of data, and thus do not require latency to be eliminated.

The processes not requiring latency to be eliminated include, for example, an image editing process of scaling image data and a compression-decompression process of compressing and decompressing image data.

In the image editing process, the image processing unit 100 transmits memory read requests to the CPU 30, and acquires image data stored in the memory 40. The image processing unit 100 then performs a process of scaling the acquired image data, transmits memory write requests to the CPU 30, and transfers the processed image data to the memory 40.

In the compression-decompression process, the image processing unit 100 transmits memory read requests to the CPU 30, acquires image data stored in the memory 40, and performs a compression process on the acquired image data. The image processing unit 100 then transmits memory write requests to the CPU 30, and transfers the compressed image data to the memory 40. Further, the image processing unit 100 transmits memory read requests to the CPU 30, and acquires the compressed image data stored in the memory 40. The image processing unit 100 then performs a decompression process on the acquired image data, transmits memory write requests to the CPU 30, and transfers the decompressed image data to the memory 40.

The image data transfer for the above-described image editing process or compression-decompression process by the image processing unit 100 is not required to take place in proper timing with the operation of an external device. Failure to transfer a predetermined amount of image data within a predetermined time period, therefore, does not cause the above-described abnormal image. The image data transfer for the image editing process or the compression-decompression process, therefore, does not require latency to be eliminated.

To eliminate latency, the amount of data transfer requests may be limited in accordance with the rate of data transfer. If the amount of data transfer requests is limited in a process of the image processing unit 100 not requiring the elimination of latency, however, the data transfer may be limited, degrading the overall performance of the image processing apparatus 1, as described above. Contrastively, if the amount of data transfer requests is not limited in a process of the image processing unit 100 requiring the elimination of latency, latency and a resultant abnormal image may be caused.

According to the present embodiment, the image processing unit 100 that performs a variety of image processing is prevented from being degraded in overall performance, while limiting the amount of data transfer requests to eliminate latency.

A detailed configuration of the image processing unit 100 according to the present embodiment will now be described.

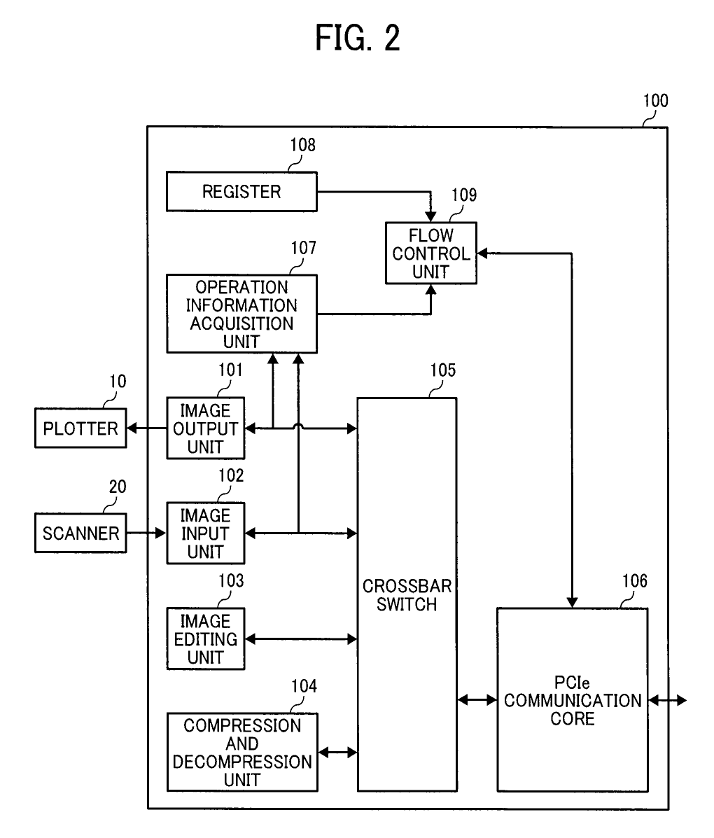

FIG. 2 is a block diagram illustrating an example of a configuration of the image processing unit 100 according to the present embodiment. As illustrated in FIG. 2, the image processing unit 100 includes an image output unit 101, an image input unit 102, an image editing unit 103, a compression and decompression unit 104, a crossbar switch 105, a PCIe communication core 106, an operation information acquisition unit 107, a register 108, and a flow control unit 109.

As described above, the image output unit 101 acquires image data stored in the memory 40 and transfers the acquired image data to the plotter 10. Specifically, the image output unit 101 transmits memory read requests to the CPU 30 via the crossbar switch 105 and the PCIe communication core 106, acquires image data transferred from the CPU 30 in response to the memory read requests, and transfers the acquired image data to the plotter 10. As described above, the image output unit 101 needs to transfer data in proper timing with the operation of the plotter 10, which is an external device. That is, the image output unit 101 is a module requiring the elimination of latency.

As described above, the image input unit 102 transfers the scanned data generated by the scanner 20 to the memory 40. Specifically, the image input unit 102 transmits memory write requests to the CPU 30 via the crossbar switch 105 and the PCIe communication core 106, and transfers the scanned data generated by the scanner 20. As described above, the image input unit 102 needs to transfer data in proper timing with the operation of the scanner 20, which is an external device. That is, the image input unit 102 is also a module requiring the elimination of latency.

A module subjected to a predetermined restriction in data transfer, i.e., requiring a predetermined amount of image data to be transferred within a predetermined time period, and thus requiring the elimination of latency, such as the image output unit 101 or the image input unit 102, will hereinafter be referred to as the transfer restricted module.

As described above, the image editing unit 103 performs the image editing process, such as scaling, format conversion, rotation, and stamping of image data. Specifically, the image editing unit 103 transmits memory read requests to the CPU 30 via the crossbar switch 105 and the PCIe communication core 106, and acquires image data transferred from the CPU 30 in response to the memory read requests.

The image editing unit 103 then performs the image editing process on the acquired image data, transmits memory write requests to the CPU 30 via the crossbar switch 105 and the PCIe communication core 106, and transfers the image data subjected to the image editing process. As described above, the image editing unit 103 is not required to transfer data in proper timing with the operation of an external device. The image editing unit 103 is therefore a module not requiring the elimination of latency.

As described above, the compression and decompression unit 104 performs the process of compressing and decompressing image data. Specifically, the compression and decompression unit 104 transmits memory read requests to the CPU 30 via the crossbar switch 105 and the PCIe communication core 106, and acquires image data transferred from the CPU 30 in response to the memory read requests. The compression and decompression unit 104 then performs the process of compressing the acquired image data, transmits memory write requests to the CPU 30 via the crossbar switch 105 and the PCIe communication core 106, and transfers the compressed image data.

The compression and decompression unit 104 further transmits memory read requests to the CPU 30 via the crossbar switch 105 and the PCIe communication core 106, and acquires the compressed image data transferred from the CPU 30 in response to the memory read requests. The compression and decompression unit 104 then performs the process of decompressing the acquired compressed image data, transmits memory write requests to the CPU 30 via the crossbar switch 105 and the PCIe communication core 106, and transfers the decompressed image data. As described above, the compression and decompression unit 104 is not required to transfer data in proper timing with the operation of an external device. The image compression and decompression unit 104 is therefore a module not requiring the elimination of latency.

The crossbar switch 105 is a connection switching unit for transmitting and receiving data between the above-described modules and the PCIe communication core 106. In accordance with the control of the later-described flow control unit 109, the PCIe communication core 106 transmits to the CPU 30 the data transfer requests transmitted from the modules via the crossbar switch 105. The PCIe communication core 106 further transfers, via the crossbar switch 105, the image data transferred from the CPU 30 to the modules having transmitted the memory read requests. The operation of the PCIe communication core 106 according to the control of the flow control unit 109 will be described in detail later.

The operation information acquisition unit 107 monitors buses connecting the transfer restricted modules and the crossbar switch 105, acquires operation information of the transfer restricted modules, and outputs the operation information to the flow control unit 109. In the present embodiment, for example, the operation information acquisition unit 107 monitors a bus connecting the image output unit 101 and the crossbar switch 105 and a bus connecting the image input unit 102 and the crossbar switch 105, and acquires the operation information of these modules (i.e., the image output unit 101 and the image input unit 102).

The operation information of a module includes the latency in the data transfer process in response to the data transfer requests transmitted by the module and information indicating an operating state or a non-operating state of the module (hereinafter referred to as the operation state information). Specifically, for example, the operation information acquisition unit 107 acquires, as the latency, the period from the time of issuance (i.e., transmission) of the memory read requests by the image output unit 101 to the time of completion of receipt by the image output unit 101 of image data transferred in response to the memory read requests. That is, the operation information acquisition unit 107 functions as a delay time measurement unit that measures a delay time in data transfer occurring in the data transfer process.

Further, for example, during data communication on the bus connecting the image output unit 101 and the crossbar switch 105, the operation information acquisition unit 107 acquires operation state information indicating that the module (i.e., the image output unit 101) is operating. That is, the operation information acquisition unit 107 functions as an operation state information acquisition unit that acquires the operation state information of a predetermined module that issues the data transfer requests.

The register 108 is a storage area for storing information necessary for the control of the flow control unit 109. Specifically, for example, the register 108 stores a latency threshold, i.e., the threshold for the latency acquired by the operation information acquisition unit 107, and a credit limiting value used to limit credit. The latency threshold and the credit limiting value are predetermined by, for example, an administrator of the image processing apparatus 1. A detailed description of the limitation on the credit will be given later.

When data transfer requests are transmitted from a transfer restricted module, the flow control unit 109 performs a flow control based on the operation information input from the operation information acquisition unit 107 and the information stored in the register 108. The flow control is a process of controlling a flow of processes related to a sequence of data transfers through the PCIe communication core 106, such as the transmission of data transfer requests and the data transfer in response to the data transfer requests.

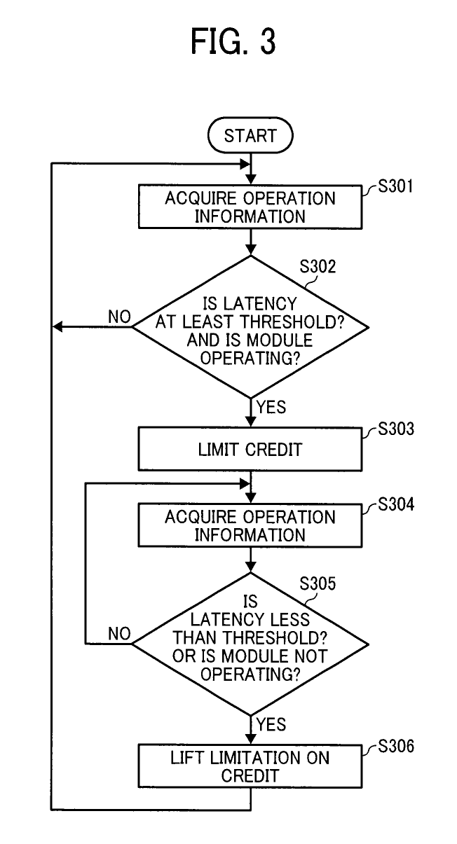

FIG. 3 is a flowchart illustrating an example of a specific operation of the flow control performed by the flow control unit 109. As illustrated in FIG. 3, the flow control unit 109 acquires the operation information input from the operation information acquisition unit 107 (step S301). The flow control unit 109 having acquired the operation information determines whether or not the latency indicated by the acquired operation information equals or exceeds the latency threshold stored in the register 108 and whether or not the operation state information indicates that the corresponding module is operating (step S302).

If the latency indicated by the acquired operation information is less than the latency threshold, or if the operation state information indicates that the corresponding module is not operating (NO at step S302), the flow control unit 109 stands by to acquire the next operation information input from the operation information acquisition unit 107 (step S301). Although the operation information acquisition unit 107 periodically outputs the operation information to the flow control unit 109 in the present embodiment, the flow control unit 109 may request the operation information acquisition unit 107 to transmit the operation information as necessary.

If the latency indicated by the acquired operation information equals or exceeds the latency threshold, and if the operation state information indicates that the corresponding module is operating (YES at step S302), the flow control unit 109 instructs the PCIe communication core 106 to limit the credit (step S303). The credit is a concept used in flow control specified in PCIe. The credit value corresponds to the amount of data receivable by the CPU 30 that receives data transfer requests (i.e., available buffer capacity in the CPU 30). That is, the credit value corresponds to the amount of data transmittable by the image processing unit 100 that transmits data transfer requests.

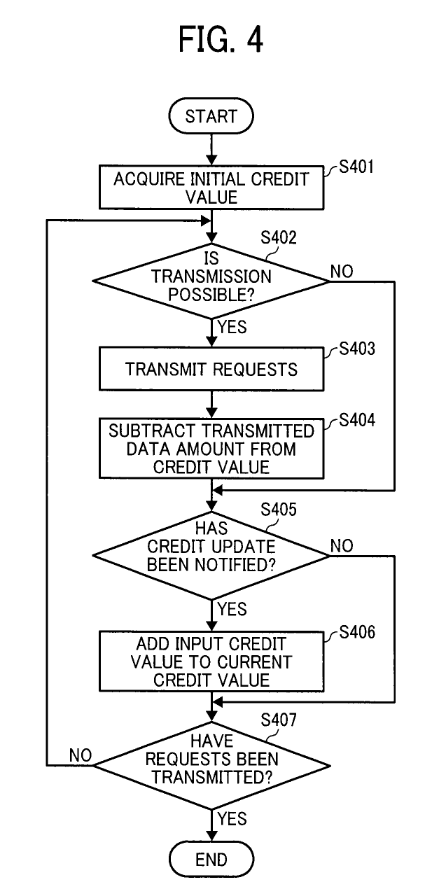

The limitation on the credit is a process of limiting the amount of data transmittable by the image processing unit 100. That is, the limitation on the credit limits the transmission amount of data transfer requests issued by a transfer restricted module, the operation information of which has been acquired. In other words, the flow control unit 109 functions as a transfer control unit that limits the transmission amount of data transfer requests issued by the transfer restricted module, if the latency indicated by the acquired operation information equals or exceeds the latency threshold and the operation state information indicates that the transfer restricted module is operating. Details of the credit and the limitation on the credit will be described later with reference to FIGS. 4 to 6B.

The flow control unit 109 having instructed the PCIe communication core 106 to limit the credit acquires the operation information from the operation information acquisition unit 107 (step S304). The flow control unit 109 having acquired the operation information determines whether or not the latency indicated by the acquired operation information is less than the latency threshold stored in the register 108 or whether or not the operation state information indicates that the corresponding module is not operating (step S305).

If the latency indicated by the acquired operation information equals or exceeds the latency threshold, and if the operation state information indicates that the corresponding module is operating (NO at step S305), the flow control unit 109 stands by to acquire the next operation information input from the operation information acquisition unit 107 (step S304). Although the operation information acquisition unit 107 periodically outputs the operation information to the flow control unit 109 in the present embodiment, the flow control unit 109 may request the operation information acquisition unit 107 to transmit the operation information as necessary.

If the latency indicated by the acquired operation information is less than the latency threshold, or if the operation state information indicates that the corresponding module is not operating (YES at step S305), the flow control unit 109 instructs the PCIe communication core 106 to lift the limitation on the credit (step S306). The flow control unit 109 having instructed the PCIe communication core 106 to lift the limitation on the credit returns to the process of step S301 to repeat the process and the subsequent processes during the operation of the image processing apparatus 1.

Details of the operation performed by the PCIe communication core 106 will now be described.

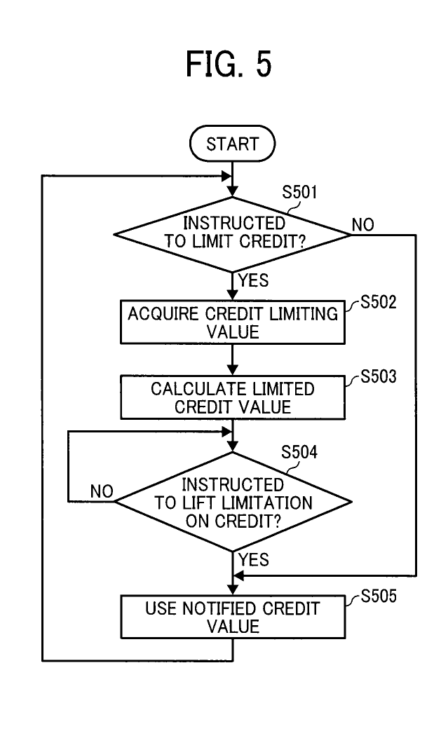

FIG. 4 is a flowchart illustrating an example of the operation of controlling the transmission of data transfer requests performed by the PCIe communication core 106 based on the credit. FIG. 5 is a flowchart illustrating an example of the operation performed by the PCIe communication core 106 in response to the instruction from the flow control unit 109 to limit the credit. The flow control based on the credit is implemented by data link layer packets (DLLPs) generated by a data link layer of PCIe.

As illustrated in FIG. 4, when a link with the CPU 30 is established, the PCIe communication core 106 acquires from the CPU 30 an initial credit value corresponding to an initial data amount receivable by the CPU 30 (step S401). The PCIe communication core 106 having acquired the initial credit value determines whether or not the transmission of data transfer requests is possible (step S402). Specifically, the PCIe communication core 106 determines whether or not the acquired credit value equals or exceeds the amount of data transfer requests.

If the transmission of data transfer requests is possible (YES at step S402), the PCIe communication core 106 transmits to the CPU 30 the data transfer requests input from the module via the crossbar switch 105 (step S403). The PCIe communication core 106 having transmitted the data transfer requests subtracts the data amount of the transmitted data transfer requests from the acquired credit value (step S404).

The PCIe communication core 106 having subtracted the data amount of the transmitted data transfer requests from the acquired credit value determines whether or not notification of credit update has been received from the CPU 30 (step S405). The CPU 30 outputs a predetermined credit value (e.g., buffer capacity corresponding to the received data) to the PCIe communication core 106 as the notification of credit update. In the present embodiment, the CPU 30 transmits the notification of credit update to the PCIe communication core 106 upon each receipt of data transfer requests.

If the notification of credit update has been received from the CPU 30 (YES at step S405), the PCIe communication core 106 adds the credit value input from the CPU 30 to the current credit value to update the credit value (step S406). Thereby, the amount of data transmittable by the image processing unit 100 is restored. The PCIe communication core 106 having added the input credit value to the current credit value determines whether or not the transmission of the data transfer requests input from the module via the crossbar switch 105 has been completed (step S407).

If the transmission of the data transfer requests has been completed (YES at step S407), the PCIe communication core 106 completes the process. If the transmission of the data transfer requests has not been completed (NO at step S407), the PCIe communication core 106 returns to the process of step 5402 to repeat the process and the subsequent processes.

Further, if the acquired credit value is insufficient to transmit the data transfer requests (NO at step S402), the PCIe communication core 106 determines whether or not the notification of credit update has been received from the CPU 30, without transmitting the data transfer requests (step S405). Further, if the notification of credit update has not been received from the CPU 30 (NO at step S405), the PCIe communication core 106 determines whether or not the transmission of the data transfer requests has been completed, without updating the credit value (step S407).

An operation performed by the PCIe communication core 106 in response to the instruction from the flow control unit 109 to limit the credit will now be described with reference to FIG. 5.

As illustrated in FIG. 5, the PCIe communication core 106 determines whether or not the instruction to limit the credit has been received from the flow control unit 109 (step S501). If the instruction to limit the credit has been received from the flow control unit 109 (YES at step S501), the PCIe communication core 106 acquires the credit limiting value stored in the register 108 (step S502).

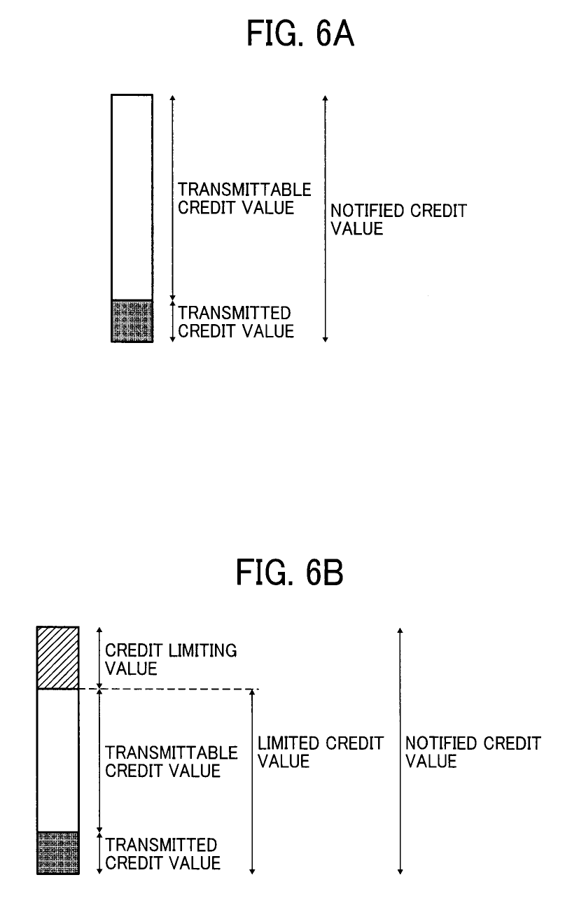

The PCIe communication core 106 having acquired the credit limiting value calculates a limited credit value used in a credit-limited state based on the acquired credit limiting value (step S503). FIGS. 6A and 6B are diagrams conceptually illustrating examples of the credit value. FIG. 6A illustrates examples of the credit value in a credit-unlimited state. FIG. 6B illustrates examples of the credit value in the credit-limited state.

As illustrated in FIG. 6A, in the credit-unlimited state, a transmittable credit value is obtained by subtracting the credit value corresponding to the data amount transmitted in response to the data transfer requests from the credit value notified by the CPU 30.

As illustrated in FIG. 6B, in the credit-limited state, the transmittable credit value is obtained by subtracting the credit value corresponding to the data amount transmitted in response to the data transfer requests not from the credit value notified by the CPU 30 but from the limited credit value. Further, as illustrated in FIG. 6B, the limited credit value is obtained by subtracting the credit limiting value acquired at step S502 from the credit value notified by the CPU 30.

In the credit-limited state, the PCIe communication core 106 thus limits the credit by performing the flow control based on the limited credit value smaller than the original credit value used in the credit-unlimited state.

Returning to FIG. 5, the PCIe communication core 106 having calculated the limited credit value determines whether or not an instruction to lift the limitation on the credit has been received from the flow control unit 109 (step S504). If the instruction to lift the limitation on the credit has been received from the flow control unit 109 (YES at step S504), the PCIe communication core 106 performs the flow control with the notified credit value illustrated in FIG. 6A (step S505). That is, the PCIe communication core 106 performs the flow control with the credit value obtained by adding the credit limiting value acquired in the process of step S502 to the limited credit value.

The PCIe communication core 106 thus performs the flow control based on the notified credit value, and repeats the above-described procedure during the operation of the image processing apparatus 1. Further, if the instruction to limit the credit has not been received from the flow control unit 109 (NO at step S501), the PCIe communication core 106 also performs the flow control by directly using the notified credit value, without calculating the limited credit value (step S505).

As described above, during the data transfer of a transfer restricted module, such as the image output unit 101 or the image input unit 102, the image processing unit 100 according to the present embodiment limits the amount of data transfer requests based on the operation state of the transfer restricted module. During the data transfer of a module not requiring a predetermined amount of image data to be transmitted within a predetermined time period, such as the image editing unit 103 or the compression and decompression unit 104, however, the image processing unit 100 does not limit the amount of data transfer requests.

This configuration allows the image processing unit 100 to monitor the state of the transfer restricted module, and limit the amount of data transfer requests to eliminate latency if the transfer restricted module is operating and the acquired latency equals or exceeds the latency threshold. The present configuration also prevents the image processing apparatus 1 from being degraded in overall performance owing to limitation on data transfer when the transfer restricted module is not operating or the acquired latency is less than the latency threshold or during the data transfer of a module not requiring the elimination of latency.

According to the present embodiment, therefore, the data transfer control device that controls the data transfer via PCTe is prevented from being degraded in overall performance, while limiting the amount of data transfer requests to eliminate latency. Further, even if the CPU 30 is a general-purpose product in which it is difficult to freely set the process of limiting data transfer requests, for example, the present embodiment eliminates latency and prevents the degradation in overall performance of the data transfer control device.

Further, in the above-described example, the image processing unit 100 according to the present embodiment calculates the limited credit value based on the credit limiting value preset in the image processing unit 100, and performs the flow control based on the limited credit value to limit the data transfer requests. With this configuration, even if the CPU 30, which serves as a device that receives the data transfer requests, is a general-purpose product in which it is difficult to freely set the credit limiting value, for example, it is possible to limit the data transfer requests. However, the configuration using the credit limiting value set in the image processing unit 100 is not essential. If the CPU 30 is capable of acquiring the limited credit value, for example, the image processing unit 100 may use the limited credit value notified by the CPU 30.

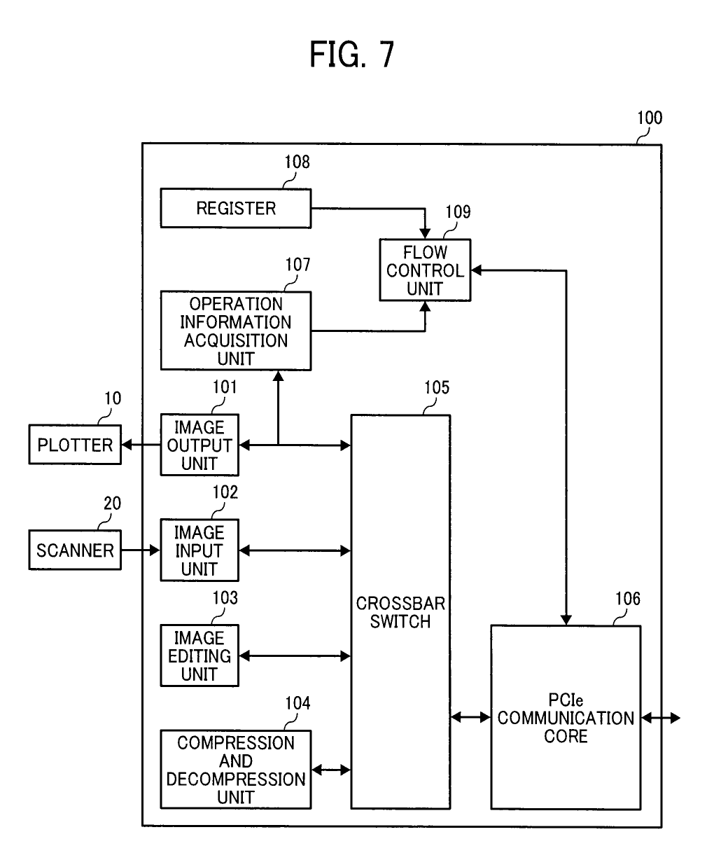

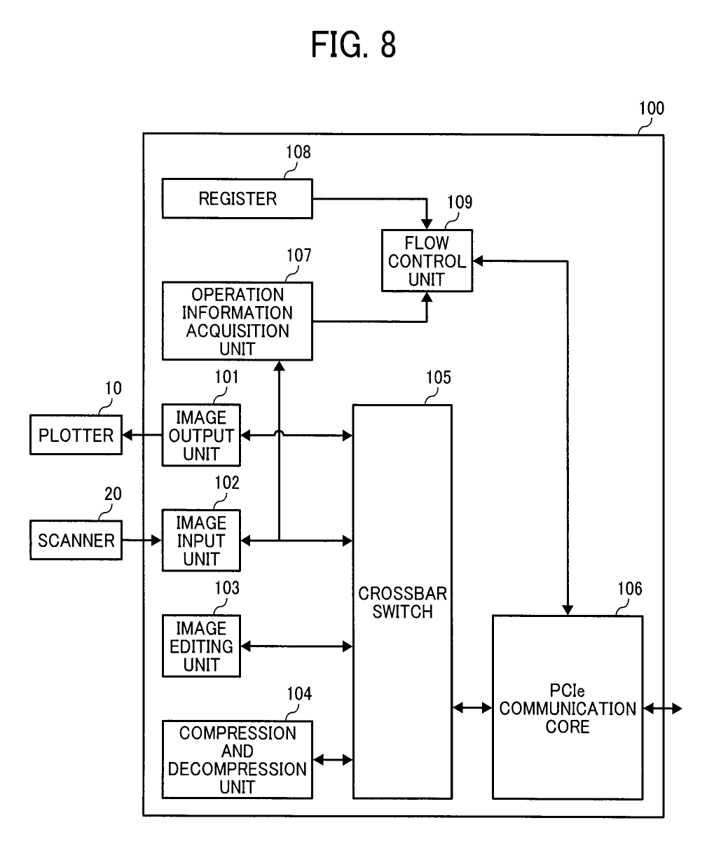

In the above-described embodiment, the operation information acquisition unit 107 monitors the bus connecting the image output unit 101 and the crossbar switch 105 and the bus connecting the image input unit 102 and the crossbar switch 105, and acquires the operation information of these modules (i.e., the image output unit 101 and the image input unit 102). Alternatively, as illustrated in FIG. 7, the operation information acquisition unit 107 may monitor only the bus connecting the image output unit 101 and the crossbar switch 105 and acquire the operation information of the image output unit 101. Further, as illustrated in FIG. 8, the operation information acquisition unit 107 may monitor only the bus connecting the image input unit 102 and the crossbar switch 105 and acquire the operation information of the image input unit 102.

As in the above examples, the present embodiment may be configured such that the operation information acquisition unit 107 does not acquire the operation information of a transfer restricted module, if the transfer restricted module is determined to have a low incidence of latency based on past occurrences of latency, for example. This configuration is still capable of preventing the degradation in overall performance of the image processing apparatus 1 while eliminating latency, and is also capable of reducing the load on the operation information acquisition unit 107 in monitoring buses.

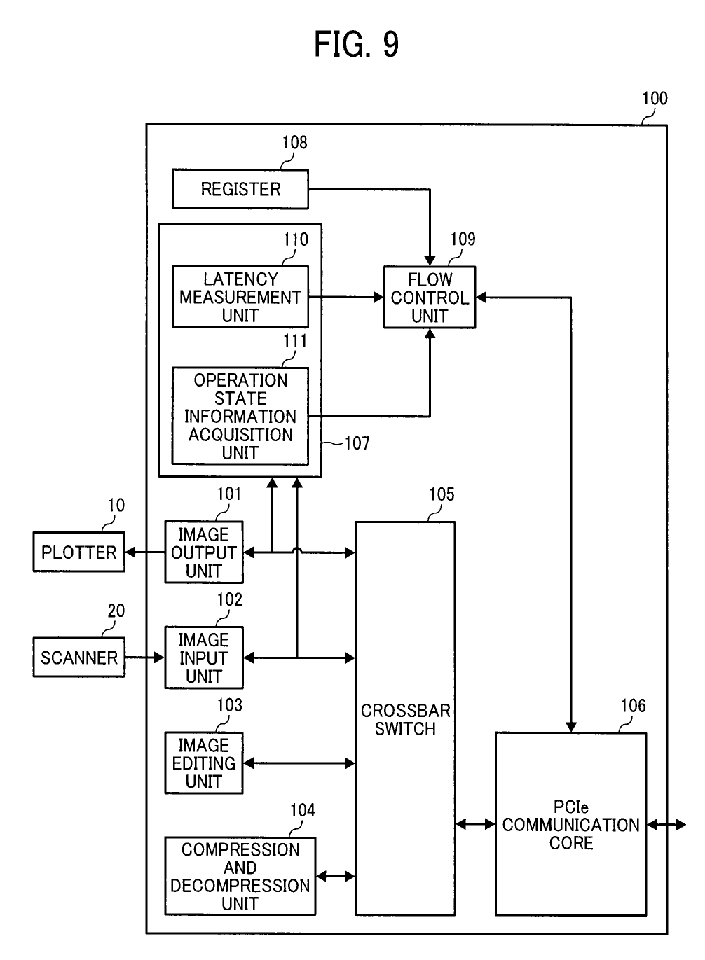

Further, in the above-described embodiment, the operation information acquisition unit 107 acquires the latency and the operation state information as the operation information. However, the present embodiment is not limited to this configuration. As illustrated in FIG. 9, the operation information acquisition unit 107 may include a latency measurement unit 110 that measures and acquires the latency and an operation state information acquisition unit 111 that acquires the operation state information. In this case, the latency measurement unit 110 functions as the delay time measurement unit.

Further, in the above-described embodiment, the image processing unit 100 included in the image processing apparatus 1 functions as the data transfer control device. However, the present embodiment is not limited to the data transfer control device included in the image processing apparatus 1, and is similarly applicable to a data transfer control device that controls data transfer via PCIe to perform a variety of processing other than image processing.

Numerous additional modifications and variations are possible in light of the above teachings. For example, elements or features of different illustrative and embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein. It is therefore to be understood that, within the scope of the appended claims, this disclosure may be practiced otherwise than as specifically described herein.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

This disclosure can be implemented in any convenient form, for example using dedicated hardware, or a mixture of dedicated hardware and software. This disclosure may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since this disclosure can be implemented as software, each and every aspect of this disclosure thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A data transfer control device to control a data transfer process based on data transfer requests, the data transfer control device comprising:
a delay time measurement unit to measure a delay time in data transfer occurring in the data transfer process;
an operation state information acquisition unit to acquire operation state information indicating one of an operating state and a non-operating state of a transfer restricted module that issues the data transfer requests and is subjected to a predetermined restriction in the data transfer; and
a transfer control unit to limit a transmission amount of the data transfer requests issued by the transfer restricted module, if the measured delay time is at least a predetermined threshold and the acquired operation state information indicates the operating state of the transfer restricted module.

2. The data transfer control device of claim 1, wherein the transfer control unit limits the transmission amount of the data transfer requests based on a difference obtained by subtracting a first value predetermined in the data transfer control device from a second value representing a data amount receivable by a request receiver that receives the data transfer requests.

3. The data transfer control device of claim 1, wherein the transfer restricted module subjected to the predetermined restriction in the data transfer performs a process requiring a predetermined amount of image data to be transferred within a predetermined time period.

4. The data transfer control device of claim 1, wherein the transfer control unit lifts the limitation on the transmission amount of the data transfer requests, if the acquired operation state information indicates the non-operating state of the transfer restricted module.

5. The data transfer control device of claim 1, wherein the transfer control unit lifts the limitation on the transmission amount of the data transfer requests, if the measured delay time is less than the predetermined threshold.

6. The data transfer control device of claim 1, wherein the transfer control unit controls the data transfer process via Peripheral Component Interconnect Express.

7. An image processing apparatus comprising the data transfer control device of claim 1, the image processing apparatus performing image processing on image data subjected to data transfer control by the data transfer control device.

8. A data transfer system comprising:
the data transfer control device of claim 1; and
a request receiver to receive the data transfer requests transmitted from the data transfer control device.

9. A data transfer control method of controlling a data transfer process based on data transfer requests, the data transfer control method comprising:
measuring a delay time in data transfer occurring in the data transfer process;
acquiring operation state information indicating one of an operating state and a non-operating state of a transfer restricted module that issues the data transfer requests and is subjected to a predetermined restriction in the data transfer; and
limiting a transmission amount of the issued data transfer requests, if the measured delay time is at least a predetermined threshold and the acquired operation state information indicates the operating state of the transfer restricted module.

10. The data transfer control method of claim 9, wherein the limiting includes:
subtracting a first predetermined value from a second value representing a data amount receivable by a request receiver that receives the data transfer requests to obtain a difference; and
limiting the transmission amount of the issued data transfer requests based on the obtained difference.

11. The data transfer control method of claim 9, further comprising:
monitoring, as the transfer restricted module, a module that performs a process requiring a predetermined amount of image data to be transferred within a predetermined time period.

12. The data transfer control method of claim 9, further comprising lifting the limitation on the transmission amount of the data transfer requests, if the acquired operation state information indicates the non-operating state of the transfer restricted module.

13. The data transfer control method of claim 9, further comprising lifting the limitation on the transmission amount of the data transfer requests, if the measured delay time is less than the predetermined threshold.
